(19) United States
(12) Patent Application Publication
(10) Pub. No.: US 2022/0063372 A1
(43) Pub. Date: Mar. 3, 2022

(54) VEHICLE AIR CONDITIONING SYSTEM

(71) Applicants: HYUNDAI MOTOR COMPANY, Seoul (KR); KIA MOTORS CORPORATION, Seoul (KR)

(72) Inventors: Gee Young Shin, Suwon-si (KR); Seung Sik Han, Hwaseong-si (KR); Dong Ho Kwon, Yongin-si (KR); Myung Hoe Kim, Seoul (KR)

(73) Assignees: HYUNDAI MOTOR COMPANY, Seoul (KR); KIA MOTORS CORPORATION, Seoul (KR)

(21) Appl. No.: 17/149,424

(22) Filed: Jan. 14, 2021

(30) Foreign Application Priority Data
Sep. 3, 2020 (KR) 10-2020-0112113

(51) Int. Cl. B60H 1/00; B60H 1/22

(52) U.S. Cl. CPC B60H 1/00921; B60H 1/2225; B60H 2001/00957; B60H 2001/00949; B60H 2001/00942

(57) ABSTRACT

A vehicle air conditioning system is provided that performs air conditioning for a front row and a rear row by using a heat pump to optimize cooling and heating efficiency, thereby preventing cooling and heating energy from being wasted.

### CROSS REFERENCE TO RELATED APPLICATION

The present application claims priority to Korean Patent Application No. 10-2020-0112113, filed Sep. 3, 2020, the entire contents of which is incorporated herein for all purposes by this reference.

### BACKGROUND

### 1. Technical Field

The present disclosure relates to a vehicle air conditioning system that performs air conditioning for a front row and a rear row by using a heat pump and implements optimization of air conditioning efficiency during cooling and heating.

### 2. Description of the Related Art

Recently, electric vehicles have emerged for solving social issues such as implementation of eco-friendly technology and energy exhaustion. The electric vehicle is operated by using a motor that outputs power by receiving electricity from a battery. Since the electric vehicle has advantages in that the electric vehicle emits no carbon dioxide, makes little noise, and has a motor with energy efficiency higher than that of an engine, the electric vehicle has been in the limelight as an eco-friendly vehicle.

A core technology for implementing such an electric vehicle is a technology related to a battery module. Recently, research on weight reduction and miniaturization of a battery, a reduction of a charging time, and the like has been actively conducted. A battery module needs to be used in an optimum temperature environment to maintain an optimum performance and a long life. However, it is difficult to realize a use in the optimum temperature environment due to heat generated during operation and a change in outside temperature.

An electric vehicle uses an electric heating device to perform indoor heating in wintertime, because there is no waste heat generated by combustion in a separate engine, unlike an internal combustion engine. In addition, an electric vehicle uses a separate electric cooling-water-heating-type heater, because warm-up is required to improve battery charge and discharge performance in cold weather conditions. In other words, in order to maintain an optimal temperature environment of a battery module, a technology of operating a cooling and heating system for controlling a temperature of a battery module separately from a cooling and heating system for indoor air conditioning in a vehicle has been used.

In a case of an air conditioning system for indoor air conditioning in a vehicle, a heat pump technology for significantly reducing heating energy consumption to increase a driving range is applied to significantly decrease energy consumption. Particularly, since a heat pump is used for a front row, and no heat pump is used for a rear row in an indoor space, air conditioning efficiency deteriorates.

The contents described as the related art have been provided only to assist in understanding the background of the present disclosure and should not be considered as corresponding to the related art known to those having ordinary skill in the art.

### SUMMARY

An object of the present disclosure is to provide a vehicle air conditioning system that performs air conditioning for a front row and a rear row by using a heat pump to optimize cooling and heating efficiency, thereby preventing cooling and heating energy from being wasted.

According to an embodiment of the present disclosure, a vehicle air conditioning system includes: a compressor that compresses a refrigerant; an external heat exchanger that condenses the refrigerant; a first air conditioner that includes an internal heat exchanger performing a heat exchange of the refrigerant compressed by the compressor, a first expansion mechanism expanding the refrigerant transferred from the external heat exchanger, and a first evaporator evaporating the refrigerant passing through the first expansion mechanism to provide air-conditioning air to an indoor space of the vehicle; and a second air conditioner that includes a second expansion mechanism expanding the refrigerant transferred from the external heat exchanger, and a second evaporator evaporating the refrigerant passing through the second expansion mechanism to provide air-conditioning air to the indoor space of the vehicle at a position different from that of the first air conditioner.

The vehicle air conditioning system may further include: a first circulation line connected from the compressor to the internal heat exchanger; a first refrigerant line connected from the internal heat exchanger to the external heat exchanger and including a third expansion mechanism provided at a front end of the external heat exchanger; a second refrigerant line connected from the external heat exchanger to the compressor, the first expansion mechanism, and the second expansion mechanism, and in which a first valve is provided on a line connected to the compressor; a third refrigerant line branched from the first refrigerant line at a front end of the third expansion mechanism, connected to the first expansion mechanism and the second expansion mechanism, and on which a second valve is provided; and a second circulation line connected from the first evaporator and the second evaporator to the compressor.

The first air conditioner may further include: a first door used to control the air-conditioning air passing through the first evaporator to pass through or bypass the internal heat exchanger; and a first heater disposed adjacent to the internal heat exchanger and generating heat.

The second air conditioner may further include: a second heater providing heat to the air-conditioning air passing through the second evaporator; and a second door used to control the air-conditioning air passing through the second evaporator and the second heater to be discharged to the indoor space of the vehicle or to the outside.

The vehicle air conditioning system may further include a control unit controlling an overall operation according to a desired temperature of the air-conditioning air discharged through the first air conditioner and the second air conditioner, and a preset mode.

In a cooling mode using the first air conditioner and the second air conditioner, the control unit may cause the refrigerant to pass through the compressor, the internal heat exchanger, the third expansion mechanism, and the external heat exchanger through the first circulation line and the second refrigerant line, and to circulate in the first expansion mechanism and the first evaporator, and the second expansion mechanism and the second evaporator. The control unit may also cause the air-conditioning air passing through the first evaporator to bypass the internal heat exchanger and be discharged to the indoor space of the vehicle by adjusting the first door. The control unit may further cause the air-conditioning air passing through the second evaporator to be discharged to the indoor space of the vehicle by adjusting the second door.

The control unit may close the first valve and the second valve, cause the first heater and the second heater not to be operated, cause the first expansion mechanism and the second expansion mechanism to expand the refrigerant, and completely open the third expansion mechanism to a maximum degree to allow the refrigerant to pass therethrough.

In a heating mode using the first air conditioner, the control unit may cause the refrigerant to pass through the compressor, the internal heat exchanger, the third expansion mechanism, and the external heat exchanger through the first circulation line and the second refrigerant line, and to circulate to the compressor again. The control unit may also cause a part of the refrigerant to circulate in the second expansion mechanism and the second evaporator through the third refrigerant line. The control unit may also cause the air-conditioning air passing through the first evaporator to pass through the first evaporator by adjusting the first door. The control unit may further cause the air-conditioning air passing through the second evaporator to be discharged to the outside by adjusting the second door.

The control unit may open the first valve and the second valve, cause the first heater to be operated, close the first expansion mechanism, and cause the second expansion mechanism and the third expansion mechanism to expand the refrigerant.

In a heating mode using the first air conditioner and the second air conditioner, the control unit may cause the refrigerant to pass through the compressor, the internal heat exchanger, the third expansion mechanism, and the external heat exchanger through the first refrigerant line and the second refrigerant line, and to circulate to the compressor again. The control unit may also cause the second heater to be operated, cause the air-conditioning air passing through the first evaporator to pass through the internal heat exchanger by adjusting the first door, and cause the air-conditioning air passing through the second evaporator to be discharged to the indoor space of the vehicle by adjusting the second door.

The control unit may open the first valve, close the second valve, cause the first heater to be operated, close the first expansion mechanism and the second expansion mechanism, and cause the third expansion mechanism to expand the refrigerant.

In a dehumidifying mode using the first air conditioner and the second air conditioner, the control unit may cause the refrigerant to pass through the compressor, the internal heat exchanger, the third expansion mechanism, and the external heat exchanger through the first refrigerant line, the second refrigerant line, and the third refrigerant line, and to circulate in the first expansion mechanism and the first evaporator, and the second expansion mechanism and the second evaporator. In this example, the control unit may also cause a part of the air-conditioning air passing through the first evaporator to pass through the internal heat exchanger by adjusting the first door. The control unit may also cause the air-conditioning air passing through the second evaporator to be discharged to the outside by adjusting the second door.

The control unit may close the first valve, open the second valve, cause the first heater to be operated, cause the first expansion mechanism and the second expansion mechanism to expand the refrigerant, and completely open the third expansion mechanism.

In a frost removing mode, the control unit may cause the refrigerant to circulate in the compressor, the internal heat exchanger, the second expansion mechanism, and the second evaporator through the first refrigerant line and the third refrigerant line. The control unit may also cause the air-conditioning air passing through the first evaporator to pass through the internal heat exchanger by adjusting the first door, and cause the air-conditioning air passing through the second evaporator to be discharged to the outside by adjusting the second door.

The control unit may close the first valve, open the second valve, close the first expansion mechanism and the third expansion mechanism, and cause the second expansion mechanism to expand the refrigerant.

The first air conditioner may be configured to provide the air-conditioning air to a front row of the vehicle, and the second air conditioner may be configured to provide the air-conditioning air to a rear row of the vehicle.

### BRIEF DESCRIPTION OF THE DRAWINGS

FIG. 1 is a circuit diagram of a vehicle air conditioning system according to the present disclosure;

FIG. 2 is a circuit diagram for describing a cooling mode in the vehicle air conditioning system illustrated in FIG. 1;

FIG. 3 is a circuit diagram for describing a heating mode using a first air conditioner in the vehicle air conditioning system illustrated in FIG. 1;

FIG. 4 is a circuit diagram for describing a heating mode using the first air conditioner and a second air conditioner in the vehicle air conditioning system illustrated in FIG. 1;

FIG. 5 is a circuit diagram for describing a dehumidifying mode using the first air conditioner in the vehicle air conditioning system illustrated in FIG. 1; and

FIG. 6 is a circuit diagram for describing a frost removing mode using the first air conditioner in the vehicle air conditioning system illustrated in FIG. 1.

### DETAILED DESCRIPTION OF THE EMBODIMENTS

Hereinafter, a vehicle air conditioning system according to an embodiment of the present disclosure is described with reference to the accompanying drawings.

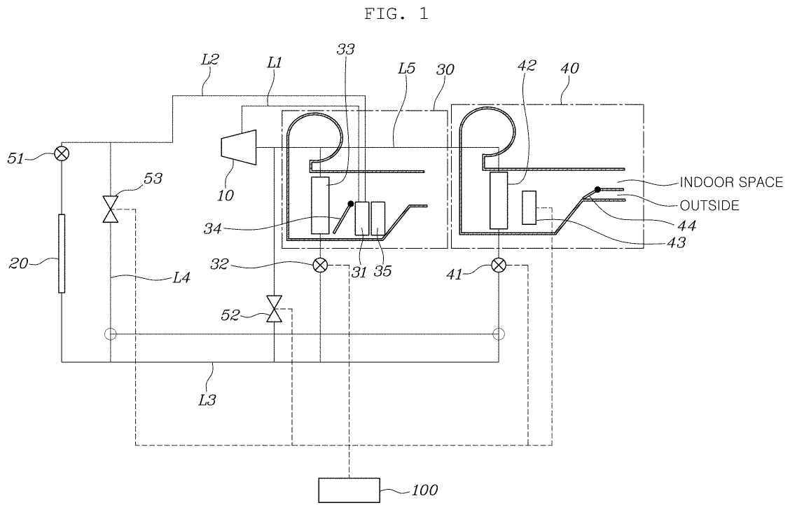

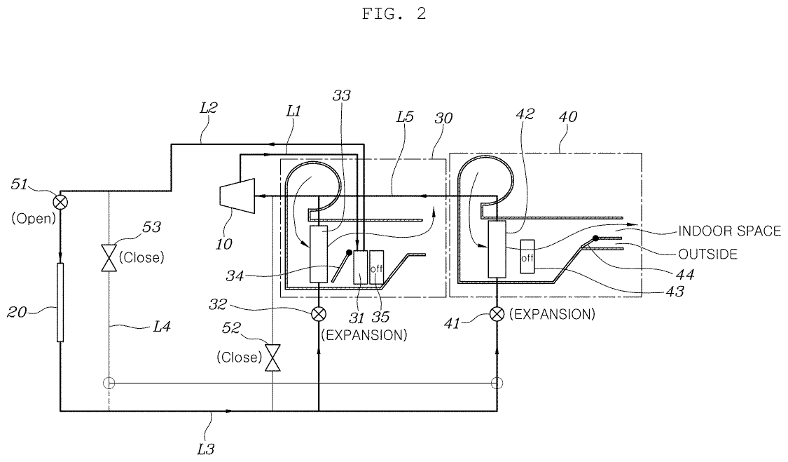

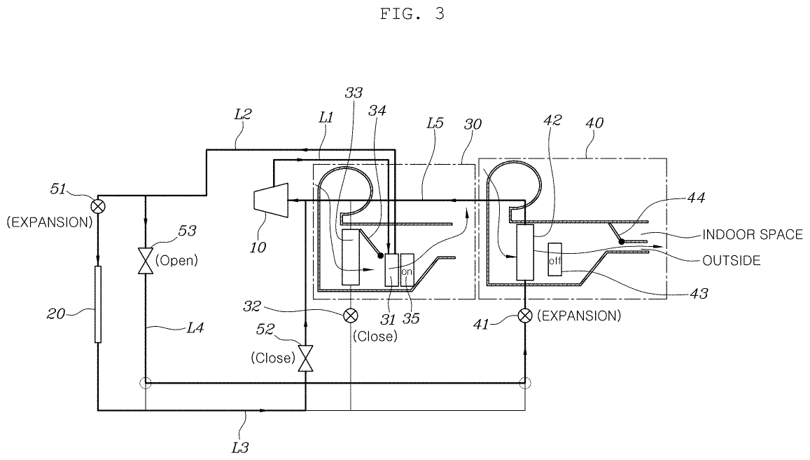

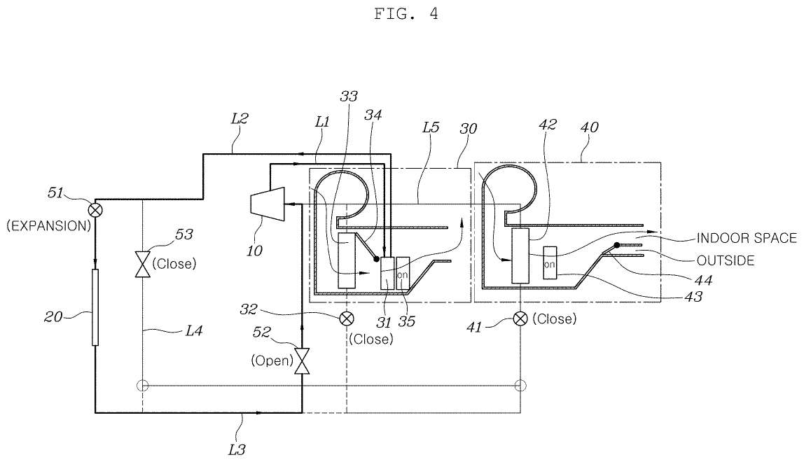

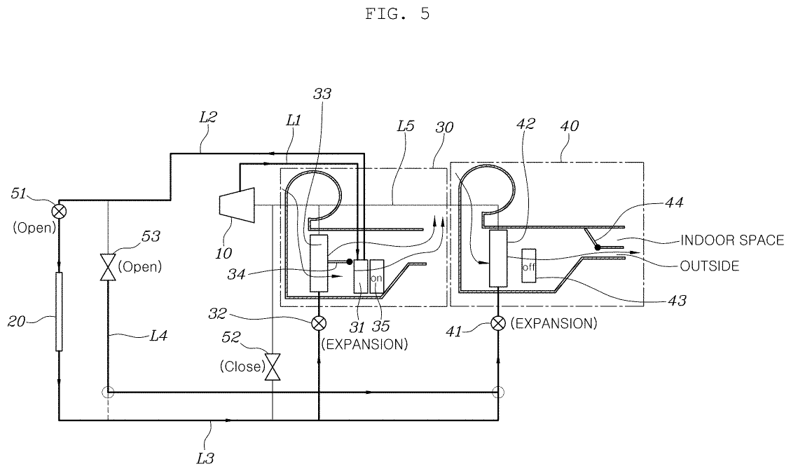

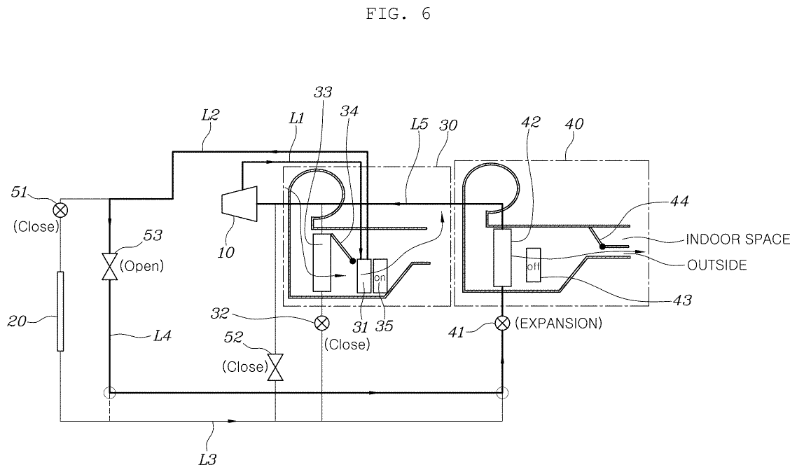

FIG. 1 is a circuit diagram of a vehicle air conditioning system according to the present disclosure. FIG. 2 is a circuit diagram for describing a cooling mode in the vehicle air conditioning system illustrated in FIG. 1. FIG. 3 is a circuit diagram for describing a heating mode using a first air conditioner in the vehicle air conditioning system illustrated in FIG. 1. FIG. 4 is a circuit diagram for describing a heating mode using the first air conditioner and a second air conditioner in the vehicle air conditioning system illustrated in FIG. 1. FIG. 5 is a circuit diagram for describing a dehumidifying mode using the first air conditioner in the vehicle air conditioning system illustrated in FIG. 1. FIG. 6 is a circuit diagram for describing a frost removing mode using the first air conditioner in the vehicle air conditioning system illustrated in FIG. 1.

As illustrated in FIG. 1, the vehicle air conditioning system according to the present disclosure includes a compressor 10 that compresses a refrigerant, an external heat exchanger 20 that condenses the refrigerant, and a first air conditioner 30. The first air conditioner includes an internal heat exchanger 31 performing a heat exchange of the refrigerant compressed by the compressor 10, a first expansion mechanism 32 expanding the refrigerant transferred from the external heat exchanger 20, and a first evaporator 33 evaporating the refrigerant passing through the first expansion mechanism 32 to provide air-conditioning air to a vehicle interior, i.e., an indoor space of the vehicle. The vehicle air conditioning system also includes a second air conditioner 40 that includes a second expansion mechanism 41 expanding the refrigerant transferred from the external heat exchanger 20, and a second evaporator 42 evaporating the refrigerant passing through the second expansion mechanism 41 to provide air-conditioning air to the indoor space of the vehicle at a position different from that of the first air conditioner 30.

The compressor 10 may be installed in a vehicle, and the external heat exchanger 20 may be installed to radiate or absorb heat through outside air. The first air conditioner 30 and the second air conditioner 40 are installed in the vehicle and provide the air-conditioning air to the indoor space of the vehicle at different positions in the indoor space, respectively. In other words, the first air conditioner 30 is configured to provide the air-conditioning air to a front row, and the second air conditioner 40 is configured to provide the air-conditioning air to a rear row, such that air conditioning using a heat pump may be performed for the front row and the rear row.

By doing so, as the refrigerant compressed by the compressor 10 circulates in the first air conditioner 30 and the second air conditioner 40, the air-conditioning air may be provided to each of the front row and the rear row. In other words, for the front row, cooling may be performed through the first evaporator 33 of the first air conditioner 30, or heating may be performed through the internal heat exchanger 31. For the rear row, cooling may be performed through the second evaporator 42 of the second air conditioner 40, or heating may be performed through a heating device as described below.

According to the present disclosure, the vehicle air conditioning system may further include a first circulation line L1 connected from the compressor 10 to the internal heat exchanger 31. The vehicle air conditioning system may also include a first refrigerant line L2 connected from the internal heat exchanger 31 to the external heat exchanger 20 and including a third expansion mechanism 51 provided at a front end of the external heat exchanger 20. The vehicle air conditioning system may also include a second refrigerant line L3 connected from the external heat exchanger 20 to the compressor 10, the first expansion mechanism 32, and the second expansion mechanism 41, and in which a first valve 52 is provided on a line connected to the compressor 10. The vehicle air conditioning system may also include a third refrigerant line L4 branched from the first refrigerant line L2 at a front end of the third expansion mechanism 51, connected to the first expansion mechanism 32 and the second expansion mechanism 41, and on which a second valve 53 is provided. The vehicle air conditioning system may also include a second circulation line L5 connected from the first evaporator 33 and the second evaporator 42 to the compressor 10.

As such, the refrigerant circulates in each circulation line and each refrigerant line. A circulation direction of the refrigerant is changed as a plurality of expansion mechanisms and a plurality of valves are opened and closed, such that the air-conditioning air at a desired temperature may be provided through the first air conditioner 30 and the second air conditioner 40.

The first expansion mechanism 32, the second expansion mechanism 41, and the third expansion mechanism 51 may each be implemented by an electronic expansion valve. Therefore, when each expansion mechanism is opened to a maximum degree, the refrigerant passes therethrough as it is without being expanded. On the contrary, when a degree of opening of each expansion mechanism is decreased to a minimum degree, the refrigerant may not pass therethrough.

The first valve 52 and the second valve 53 are configured to selectively allow refrigerant distribution through the installed refrigerant lines.

Therefore, the circulation direction of the refrigerant circulating in the first circulation line L1, the first refrigerant line L2, the second refrigerant line L3, the third refrigerant line L4, and the second circulation line L5 may be changed by the first expansion mechanism 32, the second expansion mechanism 41, the third expansion mechanism 51, the first valve 52, and the second valve 53. Thereby, the air conditioning is performed for the front row and the rear row through the internal heat exchanger 31, the first evaporator 33, and the second evaporator 42.

The first air conditioner 30 further includes a first door 34 used to control the air-conditioning air passing through the first evaporator 33 to pass through or bypass the internal heat exchanger 31. The first air conditioner 30 also includes a first heater 35 disposed adjacent to the internal heat exchanger 31 for generating heat.

The second air conditioner 40 further includes a second heater 43 providing heat to the air-conditioning air passing through the second evaporator 42 and a second door 44 used to control the air-conditioning air passing through the second evaporator 42 and the second heater 43 to be discharged to the indoor space of the vehicle or to the outside.

The first heater 35 and the second heater 43 are each implemented by a positive temperature coefficient (PTC) heater. The first door 34 and the second door 44 each change a movement path of the air-conditioning air distributed through the first air conditioner 30 and the second air conditioner 40.

Particularly, in the first air conditioner 30, the air is cooled through the first evaporator 33, and is heated through the internal heat exchanger 31 and the first heater 35. Therefore, the temperature of the air is adjusted according to an opening position of the first door 34. In the second air conditioner 40, the second evaporator 42 cools the air, and the second heater 43 heats the air, such that the temperature of the air is adjusted according to whether or not the second evaporator 42 and the second heater 43 are operated. The air-conditioning air whose temperature is adjusted is discharged to the indoor space of the vehicle or to the outside according to an opening position of the second door 44.

As a result, in the present disclosure, it is possible to optimize cooling and heating for the front row and the second row.

A detailed description thereof is provided below.

According to the present disclosure, the vehicle air conditioning system may further include a control unit 100 controlling an overall operation according to a desired temperature of the air-conditioning air discharged through the first air conditioner 30 and the second air conditioner 40. The vehicle air conditioning system may also include a preset mode. In other words, the control unit 100 may control the first expansion mechanism 32, the second expansion mechanism 41, the third expansion mechanism 51, the first valve 52, the second valve 53, the first heater 35, and the second heater 43, and may provide various air-conditioning air according to a desired indoor temperature or various modes.

Specifically, the control unit 100 may implement the cooling mode using the first air conditioner 30 and the second air conditioner 40. As illustrated in FIG. 2, the control unit 100 may cause the refrigerant to pass through the compressor 10, the internal heat exchanger 31, the third expansion mechanism 51, and the external heat exchanger 20 through the first circulation line L1, the first refrigerant line L2, and the second refrigerant line L3. The control unit 100 may also cause the refrigerant to circulate in the first expansion mechanism 32 and the first evaporator 33, and the second expansion mechanism 41 and the second evaporator 42. Further, the control unit 100 causes the air-conditioning air passing through the first evaporator 33 to bypass the internal heat exchanger 31 and be discharged to the indoor space of the vehicle by adjusting the first door 34. The control unit 100 also causes the air-conditioning air passing through the second evaporator 42 to be discharged to the indoor space of the vehicle by adjusting the second door 44.

The control unit 100 may close the first valve 52 and the second valve 53, cause the first heater 35 and the second heater 43 not to be operated, cause the first expansion mechanism 32 and the second expansion mechanism 41 to expand the refrigerant, and completely open the third expansion mechanism 51 to the maximum degree to allow the refrigerant to pass therethrough.

In other words, in the cooling mode, the cooling of the air needs to be performed through the first evaporator 33 and the second evaporator 42. To this end, the refrigerant compressed by the compressor 10 passes through the internal heat exchanger 31, passes through the third expansion mechanism 51 and the external heat exchanger 20, and moves to the first expansion mechanism 32 and the second expansion mechanism 41. In this example, the third expansion mechanism 51 is completely opened, such that the refrigerant is not expanded, and the high-temperature refrigerant radiates heat through the external heat exchanger 20. As the refrigerant moving to the first expansion mechanism 32 and the second expansion mechanism 41 is expanded through the first expansion mechanism 32 and the second expansion mechanism 41, and the refrigerant is evaporated in the first evaporator 33 and the second evaporator 42, the cooling of the air is performed. As such, the first air conditioner 30 may form cooling air through refrigerant circulation in the compressor 10, the internal heat exchanger 31, the first expansion mechanism 32, and the first evaporator 33. Likewise, the second air conditioner 40 may form cooling air through refrigerant circulation in the compressor 10, the internal heat exchanger 31, the second expansion mechanism 41, and the second evaporator 42.

Further, in the first air conditioner 30, as the first door 34 is adjusted so that the air is not distributed to the internal heat exchanger 31, bypasses the internal heat exchanger 31, and is discharged to the indoor space of the vehicle, the air cooled through the first evaporator 33 may be provided to the front row in the indoor space of the vehicle. In the second air conditioner 40, as the second door 44 is adjusted so that the air is not distributed to the outside, the air cooled through the second evaporator 42 may be provided to the rear row in the indoor space of the vehicle.

The control unit 100 may implement the heating mode using the first air conditioner 30. In this case, heating air is provided only to the front row, and is not provided to the rear row. As illustrated in FIG. 3, the control unit 100 may cause the refrigerant to pass through the compressor 10, the internal heat exchanger 31, the third expansion mechanism 51, and the external heat exchanger 20 through the first refrigerant line L2 and the second refrigerant line L3. The control unit 100 may also cause the refrigerant to circulate to the compressor 10 again and may cause a part of the refrigerant to circulate in the second expansion mechanism 41 and the second evaporator 42 through the third refrigerant line L4. Further, the control unit 100 may cause the air-conditioning air passing through the first evaporator 33 to pass through the first evaporator 33 by adjusting the first door 34 and may cause the air-conditioning air passing through the second evaporator 42 to be discharged to the outside by adjusting the second door 44. Further, the control unit 100 may open the first valve 52 and the second valve 53, cause the first heater 35 to be operated, close the first expansion mechanism 32, and cause the second expansion mechanism 41 and the third expansion mechanism 51 to expand the refrigerant. In this example, whether or not the first heater 35 is operated is determined according to a desired temperature of the air-conditioning air.

In other words, in the heating mode using the first air conditioner 30, heating air may be formed by heating the air through the internal heat exchanger 31. With the refrigerant compressed by the compressor 10, the air-conditioning air is heated by heat radiation of the internal heat exchanger 31, such that the heating air may be provided to the indoor space of the vehicle. In this example, it is possible to achieve the temperature of the air-conditioning air that is not able to be achieved only with an internal heat exchanger 31, through driving of the first heater 35 according to the temperature of the air-conditioning air. The refrigerant passing through the internal heat exchanger 31 passes through the first refrigerant line L2 and moves to the second refrigerant line L3 and the third refrigerant line L4. As the third expansion mechanism 51 is controlled to expand the refrigerant, the expanded refrigerant moves to the external heat exchanger 20 and the external heat exchanger 20 absorbs external heat. Further, as the first valve 52 is opened, the refrigerant whose temperature is increased after passing through the external heat exchanger 20 is circulated to the compressor 10, such that compression efficiency of the compressor 10 is improved. In addition, as the second valve 53 is opened, a part of the refrigerant condensed through the internal heat exchanger 31 moves to the third refrigerant line L4. As the first expansion mechanism 32 is closed, and the second expansion mechanism 41 is controlled to expand the refrigerant, the refrigerant is evaporated in the second evaporator 42. The second door 44 is adjusted to discharge the cooling air formed by the second expansion mechanism 41 to the outside.

As such, in the first air conditioner 30, as the high-temperature refrigerant compressed by the compressor 10 is provided to the internal heat exchanger 31, the heating air is formed through the internal heat exchanger 31. The first door 34 may be adjusted so that the air-conditioning air passes through the internal heat exchanger 31.

Particularly, as the refrigerant passing through the internal heat exchanger 31 circulates to the third expansion mechanism 51, the external heat exchanger 20, and the compressor 10, the refrigerant whose temperature is increased after passing through the external heat exchanger 20 circulates to the compressor 10, such that the efficiency of the compressor 10 is improved. In addition, a part of the refrigerant passing through the internal heat exchanger 31 expands in the second expansion mechanism 41, and the second evaporator 42 absorbs heat of the part of the refrigerant. Therefore, heat to be radiated to the outside is recovered by the second air conditioner 40, such that the performance of the heat pump is increased.

The control unit 100 may implement the heating mode using the first air conditioner 30 and the second air conditioner 40. In a case where the second air conditioner 40 also needs to be used in the heating mode, the second evaporator 42 should not be operated. Therefore, cooling and heating using the heat pump are not implemented.

As illustrated in FIG. 4, the control unit 100 may cause the refrigerant to pass through the compressor 10, the internal heat exchanger 31, the third expansion mechanism 51, and the external heat exchanger 20 through the first refrigerant line L2 and the second refrigerant line L3. The control unit 100 may also cause the refrigerant to circulate to the compressor 10 again, may cause the second heater 43 to be operated, may cause the air-conditioning air passing through the first evaporator 33 to pass through the internal heat exchanger 31 by adjusting the first door 34, and may cause the air-conditioning air passing through the second evaporator 42 to be discharged to the indoor space of the vehicle by adjusting the second door 44.

Further, the control unit 100 may open the first valve 52, close the second valve 53, cause the first heater 35 to be operated, close the first expansion mechanism 32 and the second expansion mechanism 41, and cause the third expansion mechanism 51 to expand the refrigerant.

In the heating mode using the first air conditioner 30 and the second air conditioner 40, the first air conditioner 30 may form heating air by heating air through the internal heat exchanger 31. The second air conditioner 40 may form heating air through the second heater 43. In other words, in the first air conditioner 30, with the refrigerant compressed by the compressor 10, the air-conditioning air is heated by heat radiation of the internal heat exchanger 31, such that the heating air may be provided to the indoor space of the vehicle. In this example, it is possible to achieve the temperature of the air-conditioning air that is not able to be achieved only with the internal heat exchanger 31, through driving of the first heater 35 according to the temperature of the air-conditioning air. In the second air conditioner 40, since cooling air is formed when driving the second evaporator 42, the air-conditioning air is heated only with the second heater 43.

Therefore, the refrigerant passing through the internal heat exchanger 31 passes through the first refrigerant line L2 and moves to the second refrigerant line L3. As the third expansion mechanism 51 is controlled to expand the refrigerant, the expanded refrigerant moves to the external heat exchanger 20, and the external heat exchanger 20 absorbs external heat. Further, as the first valve 52 is opened, the refrigerant whose temperature is increased after passing through the external heat exchanger 20 is circulated to the compressor 10, such that compression efficiency in the compressor 10 is improved. The first expansion mechanism 32 is closed, such that heat absorption through the first evaporator 33 is not performed. Further, the first heater 35 is operated to heat the air-conditioning air together with the internal heat exchanger 31. The first door 34 is adjusted so that the air-conditioning air passes through the internal heat exchanger 31 and the first heater 35. As a result, the heating air formed by the first air conditioner 30 may be provided to the front row in the indoor space of the vehicle.

The second valve 53 and the second expansion mechanism 41 are closed. Therefore, the refrigerant does not circulate in the third refrigerant line L4, such that heat absorption through the second evaporator 42 is not performed. In other words, in the second air conditioner 40, as only the second heater 43 is operated, the air-conditioning air may be heated by the second heater 43 to form the heating air. As the second door 44 is adjusted, the air-conditioning air may move to the indoor space of the vehicle to provide the heating air to the rear row in the indoor space of the vehicle.

The control unit 100 may implement the dehumidifying mode using the first air conditioner 30.

As illustrated in FIG. 5, the control unit 100 may cause the refrigerant to pass through the compressor 10, the internal heat exchanger 31, the third expansion mechanism 51, and the external heat exchanger 20 through the first refrigerant line L2, the second refrigerant line L3, and the third refrigerant line L4. The control unit 100 may also cause the refrigerant to circulate in the first expansion mechanism 32 and the first evaporator 33, and the second expansion mechanism 41 and the second evaporator 42. The control unit 100 may also cause a part of the air-conditioning air passing through the first evaporator 33 to pass through the internal heat exchanger 31 by adjusting the first door 34. The control unit 100 may also cause the air-conditioning air passing through the second evaporator 42 to be discharged to the outside by adjusting the second door 44.

Further, the control unit 100 may close the first valve 52, open the second valve 53, cause the first heater 35 to be operated, cause the first expansion mechanism 32 and the second expansion mechanism 41 to expand the refrigerant, and completely open the third expansion mechanism 51.

In other words, in the dehumidifying mode, dry air is formed through the first evaporator 33 and provided to the indoor space of the vehicle. However, the air is cooled when the first evaporator 33 is operated. Therefore, the temperature of the air-conditioning air is adjusted through the internal heat exchanger 31. The first heater 35 is operated as necessary, and the opening position of the first door 34 is adjusted, thereby adjusting the indoor temperature.

Specifically, the refrigerant passing through the internal heat exchanger 31 passes through the first refrigerant line L2 and moves to the second refrigerant line L3 and the third refrigerant line L4. In other words, the refrigerant compressed by the compressor 10 passes through the internal heat exchanger 31, passes through the third expansion mechanism 51 and the external heat exchanger 20, and moves to the first expansion mechanism 32 and the second expansion mechanism 41. In this example, the third expansion mechanism 51 is completely opened, such that the refrigerant is not expanded, and the high-temperature refrigerant radiates heat through the external heat exchanger 20. As the refrigerant moving to the first expansion mechanism 32 and the second expansion mechanism 41 is expanded through the first expansion mechanism 32 and the second expansion mechanism 41, and the refrigerant is evaporated in the first evaporator 33 and the second evaporator 42, the cooling of the air is performed. Dry air may be formed by evaporation of the refrigerant through the first evaporator 33. The second evaporator 42 absorbs heat of the circulating air to increase the temperature of the refrigerant, such that the refrigerant whose temperature is increased circulates to the compressor 10. As a result, the efficiency of the compressor 10 is improved.

In addition, the first valve 52 is closed, and the second valve 53 is opened, such that the refrigerant circulates also to the first refrigerant line L2 and the third refrigerant line L4. As a result, the circulation of the refrigerant moving to the first expansion mechanism 32 and the second expansion mechanism 41 may become smoother.

As such, in the first air conditioner 30, dry air is formed, and the opening position of the first door 34 is adjusted according to a desired indoor temperature, such that the cooling air passing through the first evaporator 33 and the heating air passing through the internal heat exchanger 31 and the first heater 35 are combined, thereby achieving the desired indoor temperature.

In the second air conditioner 40, the second door 44 is adjusted so that the cooling air formed through the second evaporator 42 is discharged to the outside.

As such, in the dehumidifying mode, air for dehumidification may be formed by using the first evaporator 33 in the first air conditioner 30. As the dehumidification proceeds, the cooled air is re-heated by the internal heat exchanger 31 and the first heater 35 to adjust the indoor temperature. In addition, as the second evaporator 42 is operated to increase the temperature of the refrigerant supplied to the internal heat exchanger 31, the temperature of the refrigerant supplied to the compressor 10 is increased, and a heat radiation amount of the internal heat exchanger 31 is increased, such that the usage of the first heater 35 may be reduced.

The control unit 100 may implement the frost removing mode. In a case where the outside temperature is low, heating is performed, and thus the internal heat exchanger 31 is not operated. As a result, frost is formed on the internal heat exchanger 31 due to an influence of the outside weather. In order to solve such a problem, the frost removing mode is set in the control unit 100.

As illustrated in FIG. 6, in the frost removing mode, the control unit 100 may cause the refrigerant to circulate in the compressor 10, the internal heat exchanger 31, the second expansion mechanism 41, and the second evaporator 42 through the first refrigerant line L2 and the third refrigerant line L4. The control unit 100 may also cause the air-conditioning air passing through the first evaporator 33 to pass through the internal heat exchanger 31 by adjusting the first door 34. The control unit 100 may also cause the air-conditioning air passing through the second evaporator 42 to be discharged to the outside by adjusting the second door 44.

Further, the control unit 100 may close the first valve 52, open the second valve 53, cause the first heater 35 to be operated, close the first expansion mechanism 32 and the third expansion mechanism 51, and cause the second expansion mechanism 41 to expand the refrigerant.

In other words, the frost removing mode may be activated when the outside temperature is low, and the internal heat exchanger 31 is operated to remove the frost.

Specifically, the refrigerant passes through the first circulation line L1 and the first refrigerant line L2 and moves to the third refrigerant line L4. In other words, as the refrigerant compressed by the compressor 10 passes through the internal heat exchanger, the temperature of the internal heat exchanger 31 is increased, such that the frost is removed. As the first valve 52, the first expansion mechanism 32, and the third expansion mechanism 51 are closed, and the second valve 53 is opened, the refrigerant passing through the internal heat exchanger 31 moves to the second expansion mechanism 41. After the second expansion mechanism 41 expands the refrigerant, the refrigerant moves to the second evaporator 42. As such, as the refrigerant circulates in the compressor 10, the internal heat exchanger 31, the second expansion mechanism 41, and the second evaporator 42, the frost may be removed by heat generated by the internal heat exchanger 31.

The vehicle air conditioning system having the above-described structure performs air conditioning for the front row and the rear row by using the heat pump to optimize cooling and heating efficiency, thereby preventing cooling and heating energy from being wasted.

Although the present disclosure has been shown and described with respect to specific embodiments, it is understood to those having ordinary skill in the art that the present disclosure may be variously modified and altered without departing from the spirit and scope of the present disclosure as defined by the following claims.

What is claimed is:

1. A vehicle air conditioning system comprising:
a compressor that compresses a refrigerant;
an external heat exchanger that condenses the refrigerant;
a first air conditioner that includes an internal heat exchanger performing a heat exchange of the refrigerant compressed by the compressor, a first expansion mechanism expanding the refrigerant transferred from the external heat exchanger, and a first evaporator evaporating the refrigerant passing through the first expansion mechanism to provide air-conditioning air to an indoor space of the vehicle; and
a second air conditioner that includes a second expansion mechanism expanding the refrigerant transferred from the external heat exchanger, and a second evaporator evaporating the refrigerant passing through the second expansion mechanism to provide air-conditioning air to the indoor space of the vehicle at a position different from that of the first air conditioner.

2. The vehicle air conditioning system of claim 1, further comprising:
a first circulation line connected from the compressor to the internal heat exchanger;
a first refrigerant line connected from the internal heat exchanger to the external heat exchanger and including a third expansion mechanism provided at a front end of the external heat exchanger;
a second refrigerant line connected from the external heat exchanger to the compressor, the first expansion mechanism, and the second expansion mechanism, and in which a first valve is provided on a line connected to the compressor;
a third refrigerant line branched from the first refrigerant line at a front end of the third expansion mechanism, connected to the first expansion mechanism and the second expansion mechanism, and on which a second valve is provided; and
a second circulation line connected from the first evaporator and the second evaporator to the compressor.

3. The vehicle air conditioning system of claim 2, wherein the first air conditioner further includes:
a first door used to control the air-conditioning air passing through the first evaporator to pass through or bypass the internal heat exchanger; and
a first heater disposed adjacent to the internal heat exchanger and generating heat.

4. The vehicle air conditioning system of claim 3, wherein the second air conditioner further includes:
a second heater providing heat to the air-conditioning air passing through the second evaporator; and
a second door used to control the air-conditioning air passing through the second evaporator and the second heater to be discharged to the indoor space of the vehicle or to the outside.

5. The vehicle air conditioning system of claim 4, further comprising a control unit controlling an overall operation according to a desired temperature of the air-conditioning air discharged through the first air conditioner and the second air conditioner, and a preset mode.

6. The vehicle air conditioning system of claim 5, wherein in a cooling mode using the first air conditioner and the second air conditioner, the control unit causes the refrigerant to pass through the compressor, the internal heat exchanger, the third expansion mechanism, and the external heat exchanger through the first refrigerant line and the second refrigerant line, and to circulate in the first expansion mechanism and the first evaporator, and the second expansion mechanism and the second evaporator, causes the air-conditioning air passing through the first evaporator to bypass the internal heat exchanger and be discharged to the indoor space of the vehicle by adjusting the first door, and causes the air-conditioning air passing through the second evaporator to be discharged to the indoor space of the vehicle by adjusting the second door.

7. The vehicle air conditioning system of claim 6, wherein the control unit closes the first valve and the second valve, causes the first heater and the second heater not to be operated, causes the first expansion mechanism and the second expansion mechanism to expand the refrigerant, and completely opens the third expansion mechanism to a maximum degree to allow the refrigerant to pass therethrough.

8. The vehicle air conditioning system of claim 5, wherein in a heating mode using the first air conditioner, the control unit causes the refrigerant to pass through the compressor, the internal heat exchanger, the third expansion mechanism, and the external heat exchanger through the first refrigerant line and the second refrigerant line, and to circulate to the compressor again, causes a part of the refrigerant to circulate in the second expansion mechanism and the second evaporator through the third refrigerant line, causes the air-conditioning air passing through the first evaporator to pass through the first evaporator by adjusting the first door, and causes the air-conditioning air passing through the second evaporator to be discharged to the outside by adjusting the second door.

9. The vehicle air conditioning system of claim 8, wherein the control unit opens the first valve and the second valve, causes the first heater to be operated, closes the first expansion mechanism, and causes the second expansion mechanism and the third expansion mechanism to expand the refrigerant.

10. The vehicle air conditioning system of claim 5, wherein in a heating mode using the first air conditioner and the second air conditioner, the control unit causes the refrigerant to pass through the compressor, the internal heat exchanger, the third expansion mechanism, and the external heat exchanger through the first refrigerant line and the second refrigerant line, and to circulate to the compressor again, causes the second heater to be operated, causes the air-conditioning air passing through the first evaporator to pass through the internal heat exchanger by adjusting the first door, and causes the air-conditioning air passing through the second evaporator to be discharged to the indoor space of the vehicle by adjusting the second door.

11. The vehicle air conditioning system of claim 10, wherein the control unit opens the first valve, closes the second valve, causes the first heater to be operated, closes the first expansion mechanism and the second expansion mechanism, and causes the third expansion mechanism to expand the refrigerant.

12. The vehicle air conditioning system of claim 5, wherein in a dehumidifying mode using the first air conditioner, the control unit causes the refrigerant to pass through the compressor, the internal heat exchanger, the third expansion mechanism, and the external heat exchanger through the first refrigerant line, the second refrigerant line, and the third refrigerant line, and to circulate in the first expansion mechanism and the first evaporator, and the second expansion mechanism and the second evaporator, causes a part of the air-conditioning air passing through the first evaporator to pass through the internal heat exchanger by adjusting the first door, and causes the air-conditioning air passing through the second evaporator to be discharged to the outside by adjusting the second door.

13. The vehicle air conditioning system of claim 12, wherein the control unit closes the first valve, opens the second valve, causes the first heater to be operated, causes the first expansion mechanism and the second expansion mechanism to expand the refrigerant, and completely opens the third expansion mechanism.

14. The vehicle air conditioning system of claim 5, wherein in a frost removing mode, the control unit causes the refrigerant to circulate in the compressor, the internal heat exchanger, the second expansion mechanism, and the second evaporator through the first refrigerant line and the third refrigerant line, causes the air-conditioning air passing through the first evaporator to pass through the internal heat exchanger by adjusting the first door, and causes the air-conditioning air passing through the second evaporator to be discharged to the outside by adjusting the second door.

15. The vehicle air conditioning system of claim 14, wherein the control unit closes the first valve, opens the second valve, closes the first expansion mechanism and the third expansion mechanism, and causes the second expansion mechanism to expand the refrigerant.

16. The vehicle air conditioning system of claim 1, wherein the first air conditioner is configured to provide the air-conditioning air to a front row of the vehicle, and the second air conditioner is configured to provide the air-conditioning air to a rear row of the vehicle.
